(19) United States
(12) Patent Application Publication
(10) Pub. No.: US 2008/0209508 A1
(43) Pub. Date: Aug. 28, 2008

(54) Digital Pen System

(76) Inventors: Manuel Angel Albarran Moyo, Barcelona (ES); Carles Ruiz Fioriach, Matano (ES); Andrew Mackenzie, Barcelona (ES)

Correspondence Address: Hewlett-Packard Company;Intellectual Property Administration, P O Box 272400, Fort Collins, CO, 80527-2400, US

(21) Appl. No.: 11/587,405

(22) PCT Filed: Apr. 22, 2005
(86) PCT No.: PCT/EP05/51795

§ 371 Date: Sep. 12, 2007

(30) Foreign Application Priority Data
Apr. 23, 2004 (GB) 0409006.4

(51) Int. Cl. H04L 9/32; G06F 1/00; G06K 9/18

(52) U.S. Cl. 726/2; 382/188

(57) ABSTRACT

A digital pen system comprising a pen 8 adapted to mark a medium 2 and a sensor 12 arranged to determine the position on the medium 2 of a mark made by the pen 8, the system being arranged to identify a plurality of different areas 500 on the medium 2 and being further arranged to authenticate a user in dependence upon authentication data input by the user, the authentication data having a value dependent upon the order in which a group of the plurality of different areas 500 of the medium 2 are marked by the pen 8.

### FIELD OF THE INVENTION

This invention relates to a digital pen system and in particular, but not exclusively, to a digital pen system arranged to provide authentication data in order to authenticate the identity of a user. The invention also provides related methods.

### BACKGROUND OF THE INVENTION

The proliferation of networked processing devices, such as computers, has led to an increased need for mechanisms to prevent unauthorised access to the processing devices and also to electronic documents accessible from the computing devices. The use of PIN's (Personal Identification Numbers), passwords and the like is well known. It will be appreciated that such use of PIN's and passwords relies upon those PIN's and passwords remaining secret and as such it is undesirable to leave written records from which the PIN or password can be determined or which make the PIN or password easier to determine.

Indeed some input mechanisms, such as the digital paper system provided by the Anoto™ company, may require that confidential information such as the PIN or password should be written down. It is not desirable to leave such information written on the paper because it could easily be found and used by other people. Thus, such input mechanisms would be insecure because they leave a trace on the paper that could later be viewed by other people.

Some applications using a digital pen and paper system may need input of confidential or private data other than a password or a PIN. Such information may be explicitly written on the paper and therefore the same problem arises.

It is also well known that use of bio-metric inputs such as finger print recognition, retina scanning is becoming known. However, in order to use such techniques specialist hardware is required which adds to the complexity and the costs of systems.

### SUMMARY OF THE INVENTION

According to a first aspect of the invention there is provided a digital pen system comprising a pen adapted to mark a medium and a sensor arranged to determine the position on the medium of a mark made by the pen, the system being arranged to identify a plurality of different areas on the medium and being further arranged to authenticate a user in dependence upon authentication data input by the user, the authentication data having a value dependent upon the order in which a group of the plurality of different areas of the medium are marked by the pen.

Such a system is advantageous in that it allows a user to be authenticated by use of a pen from a digital pen and paper system. It will be appreciated that the term pen may cover pens, styluses, pointers, or other hand held input devices.

The sensor may generate stroke data and the system may be arranged to store the stroke data for later processing or it may be arranged to process the stroke data as it is input to the system. It is also possible for the pen of the system to be arranged to process the stroke data, or to arrange another processing device of the system to process the stroke data.

According to a second aspect of the invention there is provided a method of authenticating a user comprising using a sensor of a digital pen system to generate stroke data, processing the stroke data to determine the position of marks made by the pen on a medium having a plurality of areas thereon, the method authenticating the user in dependence upon authentication data which has a value dependent upon the order in which a group of the plurality of different areas of the media are marked by the pen.

Such a method has advantages in that it allows the user of a digital pen system to use the pen thereof to authenticate the identity of that user.

According to a third aspect of the invention there is provided a digital pen system in combination with a medium, the system comprising a pen adapted to mark the medium and a sensor arranged to determine the position of a mark, made by the pen, on the medium and generate stroke data therefrom; the system being arranged to derive a set of symbols from the stroke data with each symbol in the set corresponding to one or more marks made by the pen; the system being further arranged to select according to predetermined criteria based upon the order in which the marks were made by the pen, a sub-set from the set of symbols wherein the sub-set constitutes information that it is desired to input to the system; and wherein use of the pen on the medium is such that, once the information has been entered, the marks upon the medium cannot be used to determine the information.

Such a combination is advantageous because a third party is not able to determine the information from the medium once the information has been input to the system. As such the security of the information may be increased

According to a fourth aspect of the invention there is provided a processing device arranged to receive stroke data, generated by use of a pen from a digital pen system on a medium having a plurality of areas thereon, the processing device being arranged to process the stroke data and identify a plurality of the areas of the medium marked by the pen, the device being further arranged to authenticate a user in dependence upon authentication data having a value dependent upon the order in which the areas of the medium were marked by the pen.

According to a fifth aspect of the invention there is provided a machine readable medium containing instructions which when read by a processing device cause that processing device to provide the method of the first or third aspects of the invention.

According to a sixth aspect of the invention there is provided a machine readable medium containing instructions which when read by a processing device cause that processing device to perform as at least a part of the system of the second aspect of the invention.

The machine readable medium of any of the aspects of the invention may be any one or more of the following: a floppy disk; a CD ROM/RAM; a DVD ROM/RAM (including +R/RW, −R/RW); any form of magneto optical disk; a hard drive; a memory; a transmitted signal (including an internet download, file transfer, or the like); a wire; or any other form of medium.

### BRIEF DESCRIPTION OF THE DRAWINGS

There now follows by way of example only a detailed description of the present invention with reference to the accompanying drawings in which

FIG. 1 shows a document according to an embodiment of the invention and a digital pen suitable for use with an embodiment of the invention;

FIG. 2 shows a part of a conventional position-identifying pattern applied to the document of FIG. 1 (prior art);

FIG. 3 shows an embodiment of a system for obtaining a copy of a document (prior art);

FIG. 4 shows a further view to the embodiment of FIG. 3 (prior art);

FIG. 5 shows an input area and associated input zones provided by one embodiment of the present invention;

FIG. 6 shows steps in using the input area and zones of the embodiment shown in FIG. 5;

FIG. 7 shows an expansion of the method steps shown in FIG. 6;

FIGS. 8 to 10 shows further expansions of the method steps shown in FIG. 6;

FIG. 11 shows process steps used in providing the methods described in FIGS. 6 to 10; and

FIG. 12 is a flow chart outlining method steps of a method of one embodiment of the present invention.

### DETAILED DESCRIPTION OF THE DRAWINGS

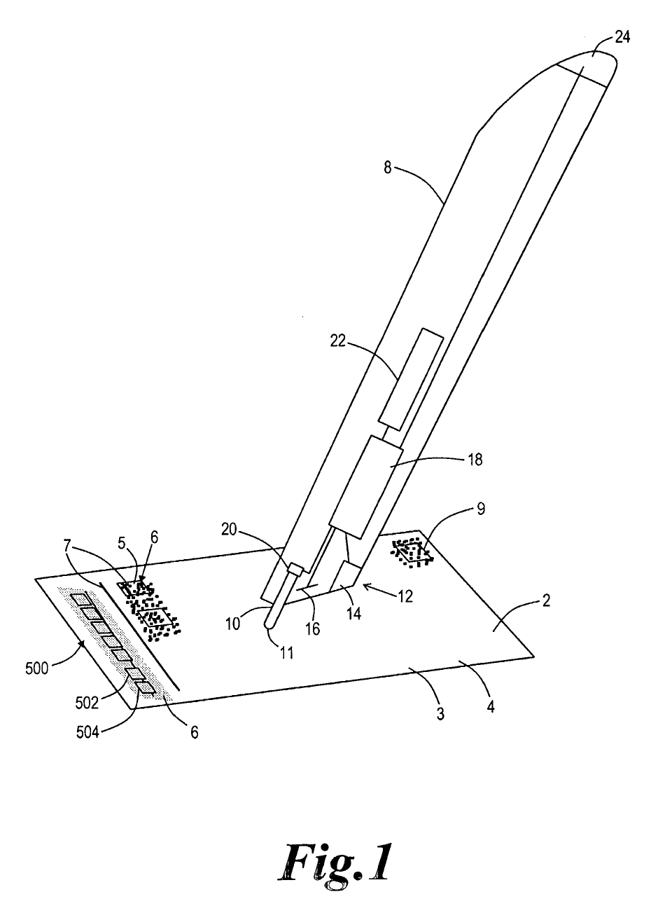

Referring to FIG. 1, there is provided a document 2 according to an embodiment of the invention for use in a digital pen and paper system which comprises a medium 3 in the form of a single sheet of paper 4 with position identifying markings 5 printed on at least some parts of it. The markings 5, which are not shown to scale in FIG. 1, form a position-identifying pattern 6 on the document 2. Also printed on the paper 4 are further markings 7 which are clearly visible to a human user of the document, and which make up the human visible content of the document 2. The content 7 is in the form of a number of lines and text and graphic features which extend over, and are therefore superimposed upon, the pattern 6.

The pen 8 comprises a writing nib 10, and a camera 12 made up of an infrared (IR) LED 14 and a CMOS sensor 16. The camera 12 provides a sensor of the digital pen system. The camera 12 is arranged to image a circular area adjacent to the tip 11 of the pen nib 10. A processor 18 processes images from the camera 12 taken at a predetermined rapid sample rate. A pressure sensor 20 detects when the nib 10 is in contact with the document 2 and triggers operation of the camera 12. Whenever the pen is being used on an area of the document 2 having the pattern 6 on it, the processor 18 can determine from the pattern 6 the position of the nib 10 of the pen whenever it is in contact with the document 2. From this it can determine the position and shape of any marks made on the patterned areas of the document 2. This information is stored in a memory 22 in the pen as it is being used as stroke data.

When the user has finished marking the document 2, this is recorded in a document completion process, for example by making a mark with the pen 8 in a send box 9. The pen is arranged to recognise the pattern in the send box 9 and send the stroke data to a stroke interpretation system in a suitable manner, for example via a radio transceiver 24 which provides a Bluetooth™ radio link with an internet connected PC. Suitable pens 8 are available from Logitech under the trade mark Logitech Io and Nokia™ which sells a “digital pen”.

In other embodiments the pen 8 may not rely on IR to read the document identifying indicia and may instead rely on any other suitable media. For example any of the following non-exhaustive list of media may be suitable: UV light; visible light; x-ray; radio waves, any other electro-magnetic radiation.

Further, it will be appreciated that the medium 3 need not be paper and could be any other suitable material. For example, the medium 3 may any of the following non-exhaustive list: a plastics material, glass, fabric, metal, a composite of any of the following or any other material. Further, it will be appreciated that the position identifying markings need not be printed on the surface 3 of the medium and could be provided within the medium. For example, the markings 5 could be provided on the surface of a material which has subsequently been laminated.

As the pen 8 is used on the document 2 a series of strokes are made. It is useful to think of a “stroke” as a single mark drawn by the pen 8 on the document 2. Hence, a stroke period starts when the pen 8 is pressed against the document 2 and ends when the pen 2 is lifted away from the document 2. Since the pen captures samples at a given rate, a stroke will be captured as the group of image samples taken in that period. Each sample taken by the pen 8 is timestamped.

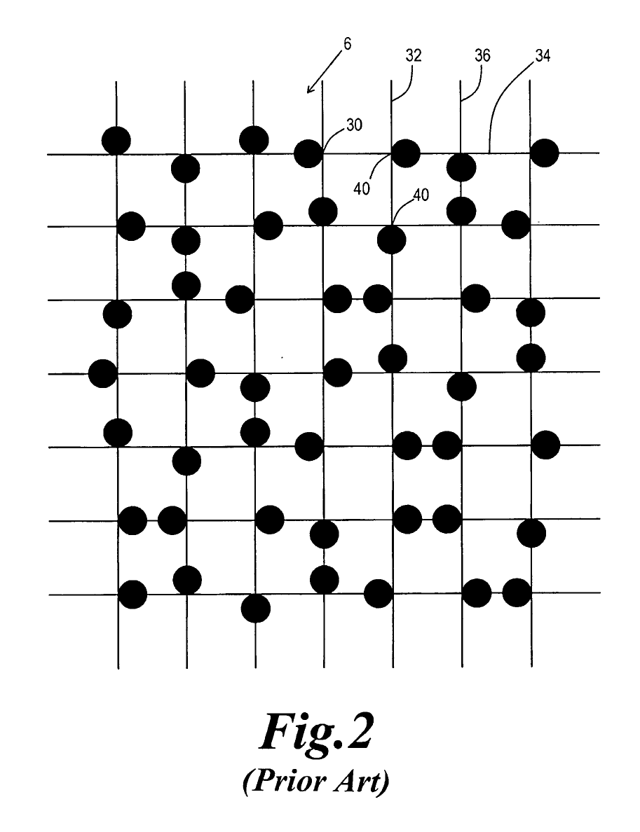

Referring to FIG. 2, the position-identifying pattern 6 is made up of a number of graphical elements comprising black ink dots 30 arranged on an imaginary grid 32. The grid 32, which is shown in FIG. 2 for clarity but is not actually marked on the document 2, can be considered as being made up of horizontal and vertical lines 34, 36 defining a number of intersections 40 where they cross. The intersections 40 are of the order of 0.3 mm apart, and the dots 30 are of the order of 100 μm across. One dot 30 is provided at each intersection 40, but offset slightly in one of four possible directions up, down, left or right, from the actual intersection 40. The dot offsets are arranged to vary in a systematic way so that any group of a sufficient number of dots 30, for example any group of 36 dots arranged in a six by six square, will be unique within a very large area of the pattern. This large area is defined as a total imaginary pattern space, and only a small part of the pattern space is taken up by the pattern on the document 2. By allocating a known area of the pattern space to the document 2, for example by means of a co-ordinate reference, the document and any position on the patterned parts of it can be identified from the pattern printed on it. An example of this type of pattern is described in WO 01/26033.

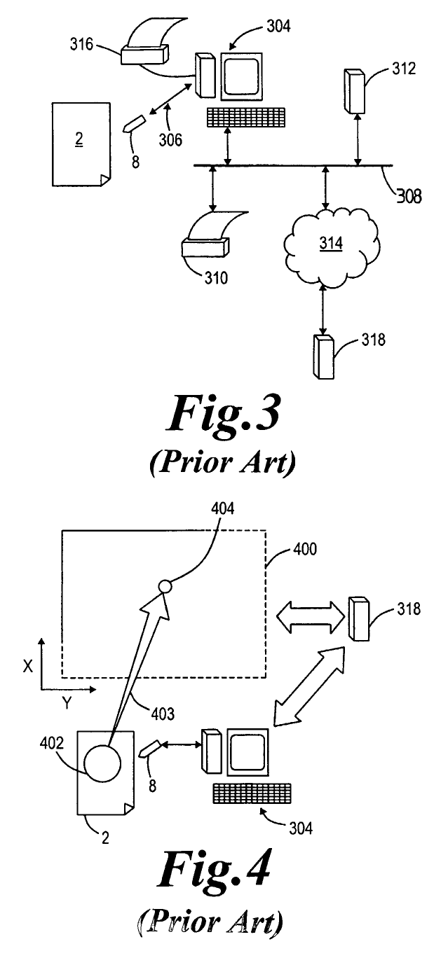

FIG. 3 shows a digital pen 8 adjacent a document 2 and connected to a computer 304 via a wireless connection 306. The computer 304 is connected to a network 308. The network 308 is also connected to a printer 310, a server 312 and a global network 304, such as the Internet. The computer 304 is also connected to what is generally termed in the art as a local printer 316 (i.e. a printer that is connected directly to a port of the computer 304).

The skilled person will appreciate that the global network 314 allows devices, such as a server 318, to be accessed from the network 308 including the computer 304.

In the embodiment shown the computer 304 is what is commonly referred to as a desktop PC; a computer that originally conformed to the IBM™ specification but which now commonly refers to a computer being compatible with the Intel™ X86 instruction set. It will be appreciated that the computer could equally comprise any other architecture of computer or indeed could comprise a machine that was not a recognised architecture. The computer may for example comprise any of the following architectures: an Apple™ PowerPC™ or other Apple™ computer, a RISC (Reduced Instruction Set Computer) machine or the like.

The network 308 is commonly referred to as an Ethernet network covered by the IEEE 802.3 standard but the skilled person will appreciate that any other network protocol may be used. The network may for example be a token ring network or may be a wireless network such as a WIFI (WIreless FIdelity as defined by the IEEE 802.11 standard), HomeRF or HiperLAN.

In the embodiment being described the pen 8 is connected to the computer 8 with a wireless connection 306. This wireless connection 306 may conveniently be provided by a Bluetooth™ connection. Other wireless protocols may also be suitable including any of the following: WIFI (WIreless FIdelity as defined by the IEEE 802.11 standard), HomeRF or HiperLAN. The skilled person will appreciate that in other embodiments a wired connection may be suitable to connect the pen 8 to the computer 304. In such embodiment the connection may be provided by means such as a USB (Universal Serial Bus) or Firewire™ (IEEE 1394) connections or the like. Connection is intended to cover any connection allowing data to be passed between the pen 8 and the computer 304.

As shown in the example shown in FIGS. 3 and 4 when the pen 8 is used on the document 2 the pen 8 stores the stroke data which is sent to the computer 304. The stroke data identifies where in the imaginary pattern space 400 the pen has been positioned. (This identification may be by determining the co-ordinates of the location in the pattern space or the like.) It will be appreciated that for reasons of scale only a portion of the pattern space 400 is shown in FIG. 4. As represented by the arrow 403 in FIG. 4 a portion 402 of position identifying pattern 6 on the document 2 is mapped to a portion 404 of the pattern space 400. How the position identifying pattern 6 is mapped to a document 2 is recorded and held on devices such as a document registry server.

The computer 304 forwards the stroke data that it has received to the server 318. The server 318 provides the stroke interpretation system that allows the stroke data to be interpreted. As discussed, the pen has determined its position in pattern space 400 and the stroke interpretation system determines the meaning of the strokes made by the pen 8. To identify the document 2, or indeed portion of the document 2, from which the stroke data has been generated a document registry server may be accessed.

Therefore the system also comprises a document registry server which in the embodiment being described is provided by the server 312. Once the stroke data has been interpreted by the stroke interpretation system the identity of the document is determined and the document registry server performs this. The result of the stroke interpretation performed by the stroke interpretation system is provided to the document registry server which returns the identity of the document; the stroke registry server maintains a record of what position-identifying pattern 6 has been provided to what document, or portion of a document 2. In the current embodiment the document registry server and the stroke interpretation system are shown as being provided by different servers 312,318. The skilled person will appreciate that this need not be the case and the same server or other processing device could provide the two functions. The term processing device is intended to cover any device that is capable of performing processing of data. Examples of processing devices include but are not limited to the following examples: a computer, a server, a digital pen, a printer, a hub and/or switch, PDA, camera, telephone, and the like.

In other embodiments the stroke interpretation system 318 and/or the document registry server 312 may be provided by any other suitable means. For example the server 312 on the network 308 and/or the computer 304 may each be able to provide the stroke interpretation system and/or the document registry server. Any suitable processing device or combination of processing devices that the pen 8 can access via the computer 304 and the networks 308 and 314 may provide the stroke interpretation system and/or the document registry server. Indeed, the pen 8 may provide the stroke interpretation system and/or the document registry server.

Thus, the combination of the stroke interpretation server (the server 318) and the document registry server (the server 312) is able to return the identity of the document, or portion thereof, on which the pen 8 is writing by interpreting the stroke data provided by the pen 8.

An embodiment of the invention is now described that allows a user to write, i.e. input, information, which may be confidential, on the digital document 2 in such a way that it is recorded by the pen 8 but the resulting trace on the document 2 becomes indecipherable as the information input.

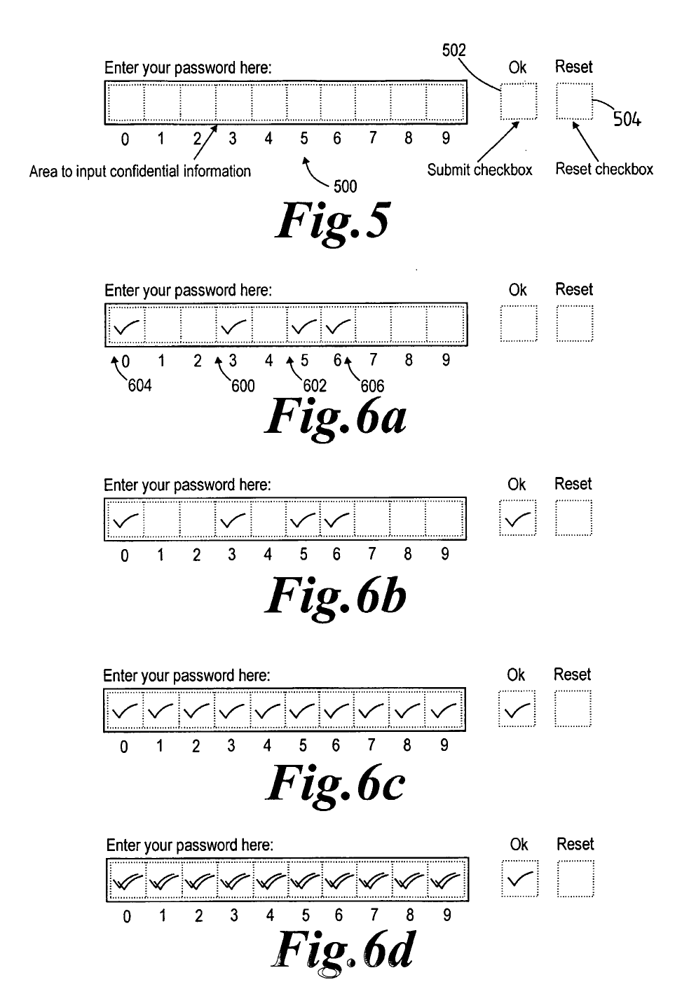

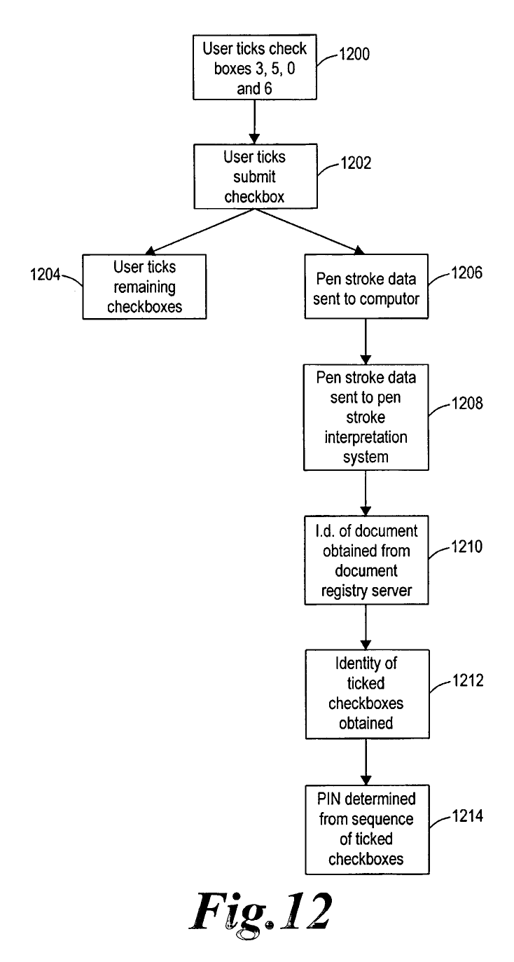

FIG. 5 depicts ten checkboxes 500, each providing an area on the medium 2, and having the symbols 0 to 9 associated therewith. Thus, the checkboxes allow information comprising a plurality of symbols to be input. An “ok” checkbox 502 and a “reset” checkbox 504 are also provided as will be explained hereinafter. FIG. 12 outlines steps of a method of using the checkboxes of FIG. 5.

The document 2 shown in FIG. 1 has a set of checkboxes marked thereon but for the sake of clarity only five checkboxes 500 are shown and the symbol associated with each checkbox has been omitted. The ok 502 and reset 504 checkboxes are shown on the document 2 of FIG. 1. The checkboxes 500, 502, 504 on FIG. 1 are shown to put into context how they appear on a document 2 with the position-identifying pattern 6.

Each checkbox is printed in an area of the document 2 that is provided with position-identifying pattern 6. Each of these checkboxes is associated unambiguously with a symbol and in the example shown in FIG. 5 the symbol is a numeral. The symbol could also be a letter or any other character.

FIG. 6 is now used to explain how the checkboxes of FIG. 5 are used, in this case to enter a PIN for example ‘3506’. Firstly, a user introduces the information by checking off the appropriated checkboxes 500 on the document (step 1200). This is represented in FIG. 6a in which the user has checked the checkboxes 600, 602, 604, 606 respectively representing the numbers 3, 5, 0 and 6. The user marks the checkboxes 600-606 in the order in which they appear in the PIN. Therefore, in this example the user ticks box 600 (number 3), then box 602 (number 5), then box 604 (number 0) and finally ticks box 606 (number 6). It will be appreciated that at this stage although the password cannot be directly inferred from the resulting trace on the checkboxes, the trace provides some information about the password (in this case the number of possible password combinations has been reduced to just 24).

Once the user has entered the information by ticking the four checkboxes 600-604 he/she ticks the ok (submit) checkbox 502 to indicate that the information has been entered (step 1202). In this embodiment the stroke data is then sent to the computer 304 for processing to determine the information (PIN) that has been entered (step 1206). This is shown in FIG. 6b. It will be appreciated that once the ok checkbox 502 has been checked then a user may check any number of further checkboxes; the ok checkbox 502 indicates the information that is being entered has finished. In the next step of the method, shown in FIG. 6c, the user ticks the remaining checkboxes 500 corresponding to a symbol which were un-ticked before the ok checkbox 502 was ticked (step 1204). Now that all of the checkboxes 500 have been ticked the number of possible password combinations has grown to 9,864,100 (notice that now the length of the password is not known either) and thus, the security of the password has been increased.

The skilled person will appreciate that the number of possible passwords that can be created is the sum of (k=1 to N) NPk where NPk denotes the number of permutations of k out of N characters: (N!/(N−k)!). If N=10 this sum is 9,864,100. This assumes that the password is between 1 and 10 characters in length. If the characters in the password is increased further (such that a checkbox may be used more than once) then this number increases further.

The computer 304 is arranged to process the stroke data and in conjunction with the stroke interpretation server (the server 318) and the document registry server (312) determines the symbols that the user marked with the pen 8. That is, in step 1028, the stroke data is sent to a stroke interpretation system (provided by server 318). The identity of the document is obtained in step 1210 from the document registry server (provided by the server 312). Once the stroke data has been interpreted and the identity of the document 2 has been obtained then the identity of the checkboxes 500 that have been ticked, before the send checkbox 502 ticked, can be obtained in step 1212. The PIN can then be determined from the order in which the checkboxes 500 were ticked in step 1214.

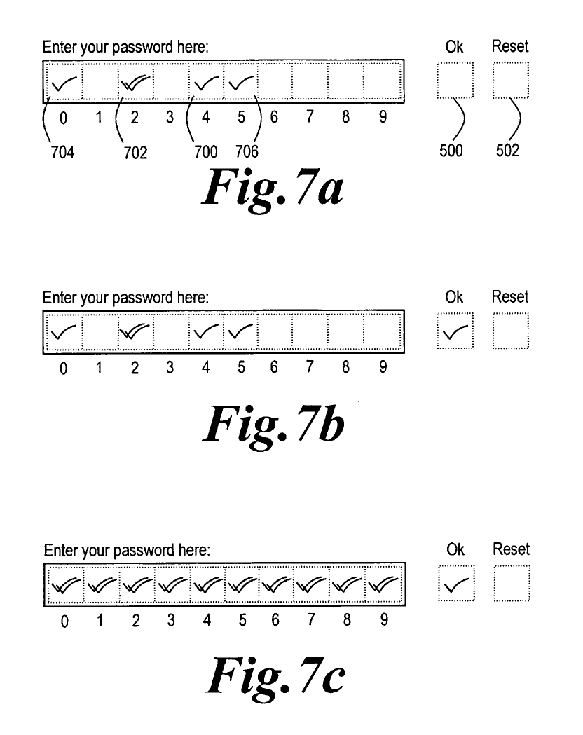

If desired and/or, depending upon the security requirements, the user may ensure that each, or a random number, of checkboxes 500 are ticked more than once. Such ticking of the checkboxes is shown in FIG. 6d and aims to make it harder for a third party to ascertain the symbols of the PIN. Another example is depicted in FIG. 7. In this case the user's password is 42025. In the first place, the user introduces the password (FIG. 7a) in the same manner as described in relation to FIG. 6. That is they tick checkboxes in the following order: checkbox 700 (numeral 4); checkbox 702 (numeral 2); checkbox 704 (numeral 0); checkbox 702 (numeral 702) and checkbox 706 (numeral 5).

After the user has marked the four checkboxes (one box was used twice) the user checks off the submit checkbox 502 (“OK” checkbox). This again causes the stroke data to be sent to the computer 304. Since a number has been introduced twice (the numeral 2 via checkbox 702), and in order to ensure the maximum privacy, in this case the user checks off all the remaining checkboxes so that they end up with two ticks (FIG. 7c).

It may be that the more times checkboxes 500 are ticked after the submit checkbox 502 is ticked the more difficult will be to infer the information (in this case the PIN) later on. The number of times the checkboxes are ticked is a trade-off that depends on the level of security required and convenience for the user.

Although the previous embodiments are described as having the reset checkbox 304 this need not be provided. As will be described later the reset checkbox 504 could allow the user to rectify the information if he/she realises that a mistake has occurred. The reset checkbox 504 may be arranged to indicate that all information entered in the checkboxes 500 is to be reset. In other embodiments the reset checkbox 504 may refer to part of the information entered in the checkboxes 500, for instance one character (i.e. one tick in one of the checkboxes) is to be removed (for example the last one).

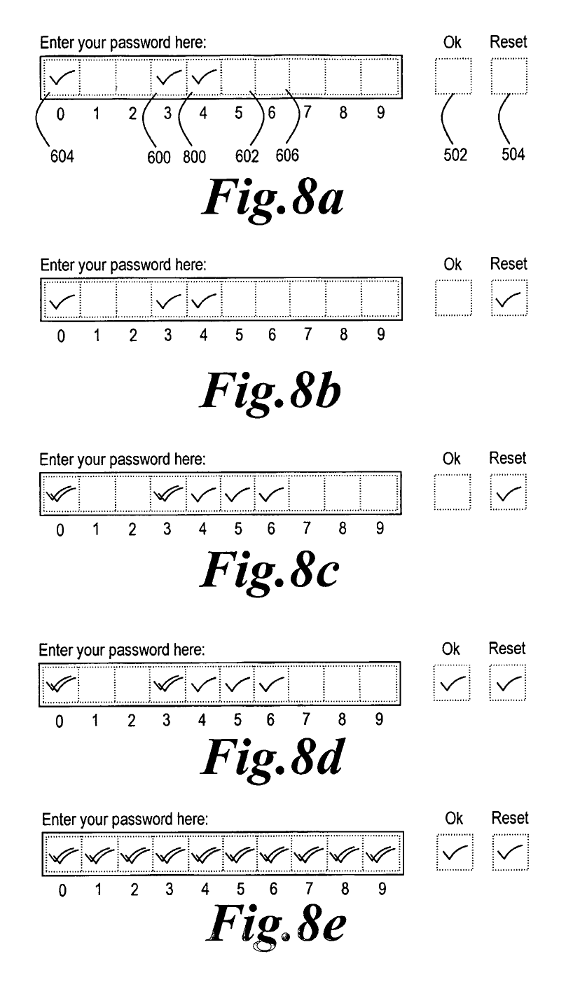

A third example shows how to use the reset checkbox 504 and is explained in relation to FIG. 8. In this example the user is to input the same PIN as shown in relation to FIG. 6 i.e. ‘3506’. For ease of reference the same reference numerals have been used as in FIG. 6. However, in this example the user makes an error before he/she ticks the submit checkbox 504.

As can be seen from FIG. 8a, the user starts ticking the checkboxes 500 and at some point he/she realises that an error has occurred because he/she ticked the numbers 3 (checkbox 600), 4 (checkbox 800) and 0 (checkbox 604) instead of 3 (checkbox 600), 5 (checkbox 602), and 0 (checkbox 604).

Once the user has discovered the error he/she then ticks the reset checkbox 504 (FIG. 8b). The user introduces again his/her PIN (FIG. 8c) and when the symbols 3506 have been entered, ticks the submit checkbox 502 (FIG. 8d). It will be appreciated that the stroke data sent to the computer 306 now comprises strokes corresponding to the symbols 3, 4 and 0, a reset checkbox, and the symbols 3, 5, 0 and 6. Software running on the computer 304 is able to interpret this information to disregard the symbols 3, 4 and 0 that were entered before the reset checkbox was ticked. Finally, as shown in FIG. 8e, and in order to mask the PIN, the user ticks all remaining checkboxes so they all get ticked twice.

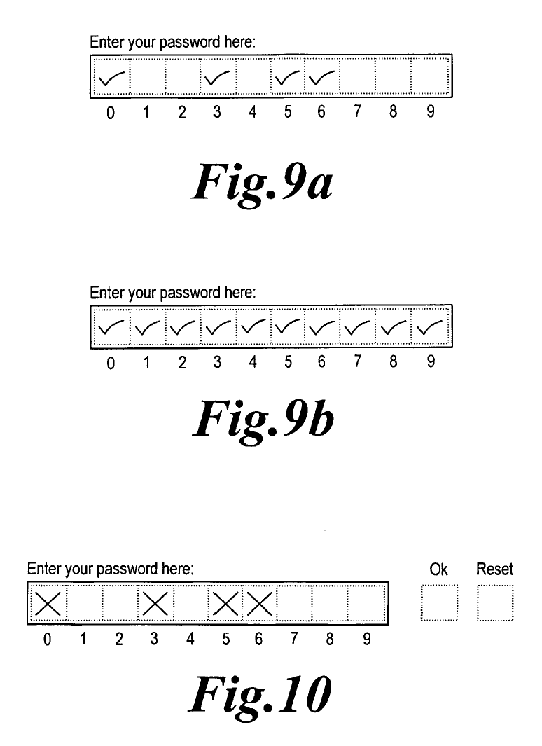

A final example shows a simplified version where no submit checkbox (“OK” checkbox) is used and is explained in relation to FIG. 9. Thus, the skilled person will appreciate that the “OK” checkbox 502 is an optional feature. This method assumes that the application verifies the password and then discards the information that follows. Hence, the information has been entered (FIG. 9a) the additional checked boxes are ticked off (FIG. 9b). Thus, in this example, the stroke data sent to the computer 304 comprises strokes that provide ten symbols when decoded. However, the first four symbols (in this example 3506) give the PIN and software processing the stroke data disregards the last six symbols; thus the symbols used are those input before predetermined stroke data is received (the predetermined stroke data comprising data providing the OK checkbox). In alternative embodiments the first n symbols provide the PIN (for example the first 4 symbols).

The skilled person will appreciate the information need not be the first n symbols entered and the method may be arranged such that, for example, the 3rd to 6th symbols entered provide the PIN. Such an arrangement may provide a means for increasing the security of the method further. In further examples, predetermined symbols may provide the PIN (for example the 2nd, 4th, 7th and 8th symbols that are entered may provide the PIN).

A further variation on the method is to use long passwords and a short number of characters. For example, if only numbers 0, 1, 2 and 3 are allowed, and the password has to be 15 symbols long, it is likely that all checkboxes will get checked off and hence there might be no need for checking off additional areas.

In the examples so far, the depicted ticks were composed of only one stroke as defined above. However, this may not be the case. FIG. 10, for instance, depicts a popular tick used by some users (a cross) that is composed of two strokes. In this case, there is the risk that a single tick might be interpreted as more than one tick in the same checkbox 500.

One way to avoid complexity in the method may be to force the user to do one-stroke ticks. A printed message on the document 2 could indicate to the user how to do this. Another solution may be to constrain the information (e.g. PIN) by not allowing two consecutive ticks in the same checkbox 500 (hence all consecutive strokes in a checkbox would be considered as belonging to the same tick).

A further solution is to program the application to recognize a single tick even in cases where multiple-stroke ticks are used. This may be done using certain time thresholds to group strokes into ticks. It is common that the time interval between strokes belonging to the same tick will be shorter than the time interval between strokes belonging to different ticks. Hence, two strokes can be considered to belong to the same tick if the timestamp value of the last sample of the first stroke is close to the timestamp value of the first sample of the following stroke.

Another solution is to perform tick recognition based on shape. Ticks usually have simple standard shapes. As we saw, for instance, a common tick is a cross, which can be easily recognized. Furthermore, a solution based on the combination of any of the methods described could be used.

In addition, it could occur that a given tick is not contained within one checkbox 500. In this case, the application will have to decide to which checkbox 500 the tick belongs. One way to do this is, for instance, to choose the checkbox that contains more samples of that tick. Other methods may be used.

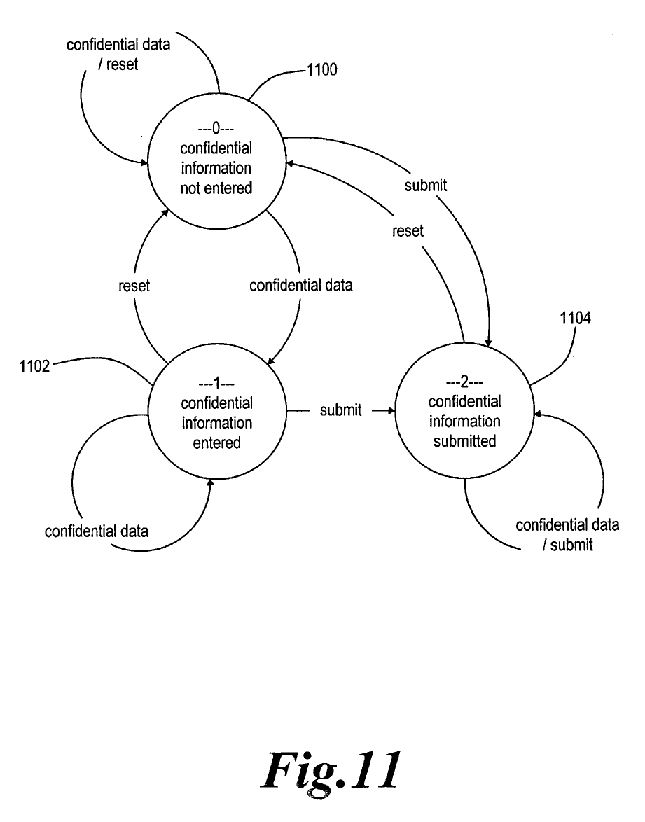

Processing of the stroke data provided by an application on the computer 304 will now be described is association with the state diagram show in FIG. 11. It is assumed here that all samples (and their associated timestamps) have been grouped into strokes (using data from the pressure sensor of the pen 8). Furthermore, using one of the techniques mentioned above, the strokes located the checkboxes 500 are grouped into ticks.

At the beginning, no confidential information has been received and hence the system is in state O 1100. If information is entered, it is stored temporarily, and the system goes to state 1 1102. In this state, the input of information is handled the same way (data is stored). Then, when the submit checkbox 502 is ticked, the system moves to state 2 1104 and the information received so far is treated provisionally as the valid information to be processed. Once no more strokes are left to process, the application will take that the information and use it for the desired purposes. Whenever the reset checkbox is checked off, the application moves to back state 0 1100 and the system erases the information entered so far. If that occurs in state 0 or 1, no information can be processed.

Simplified versions of this algorithm (e.g. no submit or reset checkboxes) can easily be deduced for those skilled in the art. A portion of pseudo code now follows that may be suitable for realising an embodiment of the invention:

```
while (Some_input_is_received)
{
      switch (In_what_state_we_are)
      {
      case We_are_in_State_0:
            if (Input_is_inside_a_password_field) then State =
State_1;
            if (Input_is_a_submit) then State = State_2;
            if (Input_is_a_reset) then State = State_0;
      case We_are_in_State_1:
            if (Input_is_a_submit) then State = State_2;
            if (Input_is_a_reset) then State = State_0;
            if (Input_is_a_inside_a_password_field) then State =
State_1;
      case We_are_in_State_2:
            if (Input_is_a_reset) then State = State_0;
            if (Input_is_a_submit) then State = State_2;
            if (Input_is_inside_a_password_field) then State =
State_2;
}
```

Although the embodiments described above have had one set of checkboxes 500 it is equally possible for a document 2 (which may be any number of pages in length) to have a plurality of sets of checkboxes 500 and/or submit 502 and/or reset 504 checkboxes.

1. A digital pen system comprising a pen adapted to mark a medium and a sensor arranged to determine the position on the medium of a mark made by the pen, the system being arranged to identify a plurality of different areas on the medium and being further arranged to authenticate a user in dependence upon authentication data input by the user, the authentication data having a value dependent upon the order in which a group of the plurality of different areas of the medium are marked by the pen.

2. A system according to claim 1 in which the sensor is arranged to generate stroke data which allows the position of a mark made by the pen to be determined.

3. A system according to claim 2 which is arranged to store the stroke data generated by the sensor within a memory of the system and is further arranged to process the stored stroke data to identify the plurality of different areas.

4. A system according to any preceding claim which further comprises a processing means having, or being able to have created, a data connection to the pen wherein the processing means is arranged to process the stroke data generated by the sensor in order to identify the plurality of different areas.

5. A system according to claim 4 in which the processing means is provided by a computer.

6. A system according to any preceding claim in which the sensor is arranged to read position identifying markings provided on the medium.

7. A system according to claim 6 in which the sensor is arranged to read position identifying markings provided by the company Anoto™.

8. A system according to any preceding claim in which the value given to the authentication data is dependent upon any one of following:
i: the first n areas marked by the pen;
ii: areas marked by the pen before predetermined stroke data is generated by the sensor;
iii: areas between the nth and mth areas marked by the pen; and
iv: areas marked at predetermined positions within the areas marked by the pen.

9. A method of authenticating a user comprising using a sensor of a digital pen system to generate stroke data, processing the stroke data to determine the position of marks made by the pen on a medium having a plurality of areas thereon, the method authenticating the user in dependence upon authentication data which has a value dependent upon the order in which a group of the plurality of different areas of the media are marked by the pen.

10. A method according to claim 9 which associates one or more strokes made by the pen with an area on the medium.

11. A method according to claim 9 or 10 in which the areas on the medium are provided by check boxes.

12. A method according to any of claims 9 to 11 comprising providing a medium having position identifying markings readable at a surface thereof.

13. A method according to claim 12 in which the position identifying markings are provided by a pattern provided by Anoto™.

14. A method according to any of claims 9 to 13 which establishes a data connection between the pen and a processing device and causes the stroke data to be processed to determine the symbols and/or the sequence on the processing device.

15. A machine readable medium containing instructions which when read by a processing device cause that processing device to provide the method of any of claims 9 to 14.

16. A machine readable medium containing instructions which when read by a processing device cause that processing device to perform as at least a part of the system of any of claims 1 to 8.

17. A digital pen system in combination with a medium, the system comprising a pen adapted to mark the medium and a sensor arranged to determine the position of a mark, made by the pen, on the medium and generate stroke data therefrom;
the system being arranged to derive a set of symbols from the stroke data with each symbol in the set corresponding to one or more marks made by the pen;
the system being further arranged to select according to predetermined criteria based upon the order in which the marks were made by the pen, a sub-set from the set of symbols wherein the sub-set constitutes information that it is desired to input to the system; and
wherein use of the pen on the medium is such that, once the information has been entered, the marks upon the medium cannot be used to determine the information.

18. A system according to claim 17 in which the medium is provided with a plurality of areas with each area having a symbol associated therewith.

19. A system according to claim 18 which is arranged to associate one or more strokes with any one of the areas to provide a symbol of the information.

20. A system according to claim 18 or 19 in which the areas are provided by check boxes.

21. A processing device arranged to receive stroke data, generated by use of a pen from a digital pen system on a medium having a plurality of areas thereon, the processing device being arranged to process the stroke data and identify a plurality of the areas of the medium marked by the pen, the device being further arranged to authenticate a user in dependence upon authentication data having a value dependent upon the order in which the areas of the medium were marked by the pen.
